(19) United States
(12) Patent Application Publication
(10) Pub. No.: US 2002/0138295 A1
(43) Pub. Date: Sep. 26, 2002

(54) Systems, methods and computer program products for processing and displaying performance information

(76) Inventor: Martin R. Ekrem, Brentwood, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/097,479

(22) Filed: Mar. 14, 2002

Related U.S. Application Data
(60) Provisional application No. 60/277,176, filed on Mar. 20, 2001.

(51) Int. Cl. G06F 17/60

(52) U.S. Cl. 705/1

(57) ABSTRACT

The reporting system includes a data repository, a user interface having a display and an audio output, and a controller interfacing with the data repository and the user interface. The controller comprises a retrieval software module adapted to retrieve data from the data repository, a processing software module adapted to process the data, a display software module adapted to display the processed data as a performance report on the display of the user interface, a text-to-speech software module interfacing with the audio output of the user interface, and an animation software module interfacing with the display software module and the text-to-speech software module. The animation software module and the text-to-speech software module are adapted to visually and aurally evaluate the performance report displayed on the display and provide improvement recommendations to the user to thereby engage and motivate the user to implement the recommendations.

### FIELD OF THE INVENTION

The present invention relates to systems, methods, and computer program products for processing and displaying financial and operational performance information.

### BACKGROUND OF THE INVENTION

A common need of most businesses is financial and operational performance information communicated in a timely and accurate way to the owners and managers of the business. Decision-making can only be as good as the available information. In addition, while owners and managers need financial and operational performance information to effectively oversee the operations of a business, providing such information to the frontline producers and/or sellers of the products or services can be equally beneficial. Thus, users of performance information can include managers, as well as individual producers, such as physicians, lawyers, CPAs, and salesmen/women.

The concept of a conventional printed “at-a-glance” financial and operational report is frequently referred to as a “dashboard report”. Business dashboard reports are designed to provide an objective view of how well a business is operating by comparing the performance information of the business to predetermined financial and operational goals and to analogous information for the industry in general. Such a comparison should allow the user of the report to judge the financial and operational performance of individuals in the business and/or to judge the financial and operational performance of an operating unit or the business as a whole. Although there is an abundance of financial and operational data available for most industries, conventional reporting systems typically do not organize and present the performance information in a manner and format that engages the user and motivates the user to make decisions.

Because businesses have become more sophisticated over the past 50 years, companies and entrepreneurs are required to have a higher level of business acumen to be successful. These companies and entrepreneurs need a performance reporting system that is capable of gathering and synthesizing the financial and operational performance data into a meaningful summary report that will motivate the user to make decisions. Financial and operational performance information is most meaningful when the information is understood easily by the user, is considered in the context of the financial and operational goals of the particular business, and is compared to other objective criteria such as local, regional and/or national industry standards or averages. The reporting system for delivering the performance information must be timely, user friendly and accurate to facilitate the user's decision making process. In addition, the reporting system must be entertaining and engaging so that the user will utilize the report and look forward to receiving the regular performance update on the business.

### SUMMARY OF THE INVENTION

In accordance with one aspect, the present invention provides a performance evaluation and improvement system for a user. The system includes a data repository electronically retaining financial and operational performance data for the user, at least one user interface having a display and at least one audio output, and a controller interfacing with the data repository and the at least one user interface. In one embodiment, the controller comprises a retrieval software module adapted to retrieve data from the data repository; a processing software module interfacing with the retrieval software module and being adapted to process the data based on predetermined parameters; a display software module interfacing with the processing software module and the at least one user interface and being adapted to display the processed data as a performance report on the display of the at least one user interface; at least one text-to-speech software module interfacing with the processing software module and the at least one audio output of the at least one user interface; and at least one animation software module interfacing with the processing software module, the display software module and the at least one text-to-speech software module.

The at least one animation software module and the at least one text-to-speech software module are adapted to visually and aurally evaluate the performance report displayed on the display and provide improvement recommendations to the user to thereby engage the user and motivate the user to implement the recommendations. According to one embodiment, the at least one animation software module provides at least one animated character on the display having a face with a mouth and body parts, such as a head, arms, legs, hands, feet, fingers, eyes, and ears that visually move separately or together on the display. According to another embodiment, the at least one text-to-speech software module provides a signal to the at least one audio output of the at least one user interface as the mouth of the animated character visually moves on the display so that the at least one audio output emits an aural signal in the form of speech.

In accordance with one aspect, the present invention also provides a method of evaluating financial and operational performance data of a user. The method includes retrieving the data of the user electronically from a data repository and providing it to a controller. The controller, according to predetermined parameters, processes the data. Signals, which can be either electrical or optical, are communicated from the controller to at least one user interface having a display and at least one audio output. Thereafter, the processed data is displayed on the display as a performance report. At least one animated character is displayed on the display and an aural signal in the form of speech is emitted from the at least one audio source such that the at least one animated character visually and aurally evaluates the performance report and provides improvement recommendations to the user to thereby engage the user and motivate the user to implement the recommendations. In one embodiment, the mouth of the animated character is moved on the display. In another embodiment, the aural signal emitted from the at least one audio output is synchronized with the movement of the mouth of the at least one animated character on the display. In another embodiment, at least one arm of the animated character is moved on the display. In yet another embodiment, at least one leg of the animated character is moved on the display. In still another embodiment, at least one hand of the animated character is moved on the display. In still another embodiment, at least one finger of the animated character is moved on the display. Other body parts of the animated character can also be moved on the display to emphasize important points or concepts. Similarly, the aural signals emitted from the at least one audio output can be used to emphasize important points or concepts.

Accordingly, there has been provided a performance reporting system and an associated method allowing for the delivery of performance information in a timely, user friendly and accurate manner. Advantageously, the reporting system includes one or more animated characters to visually and aurally entertain and engage the user so that the user will be motivated to implement the recommendations of the system and will look forward to receiving the regular performance update.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate preferred and exemplary embodiments, and which are not necessarily drawn to scale, wherein:

FIG. 1 is a block diagram illustrating the components of the reporting system for evaluating and improving user performance, according to one embodiment of the present invention;

FIG. 2 is a block diagram illustrating the retrieval of data from the data repository by the retrieval software module of FIG. 1;

FIG. 3 is a block diagram illustrating the components of the reporting system for evaluating and improving user performance, according to another embodiment of the present invention;

FIG. 4 is a block diagram illustrating the components of the reporting system for evaluating and improving user performance, according to still another embodiment of the present invention;

FIG. 5 is a table illustrating exemplary industry indicators, conditions, and responses used by the processing software modules of FIGS. 1, 3, and 4;

FIG. 6 is a block diagram illustrating the steps of evaluating and improving user performance, according to one embodiment of the present invention;

FIG. 7A is a flow chart illustrating the steps of evaluating and improving user performance, according to one embodiment of the present invention; and

FIG. 7B is a flow chart further illustrating the steps of evaluating and improving user performance, according to the embodiment of the invention illustrated in FIG. 7A.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

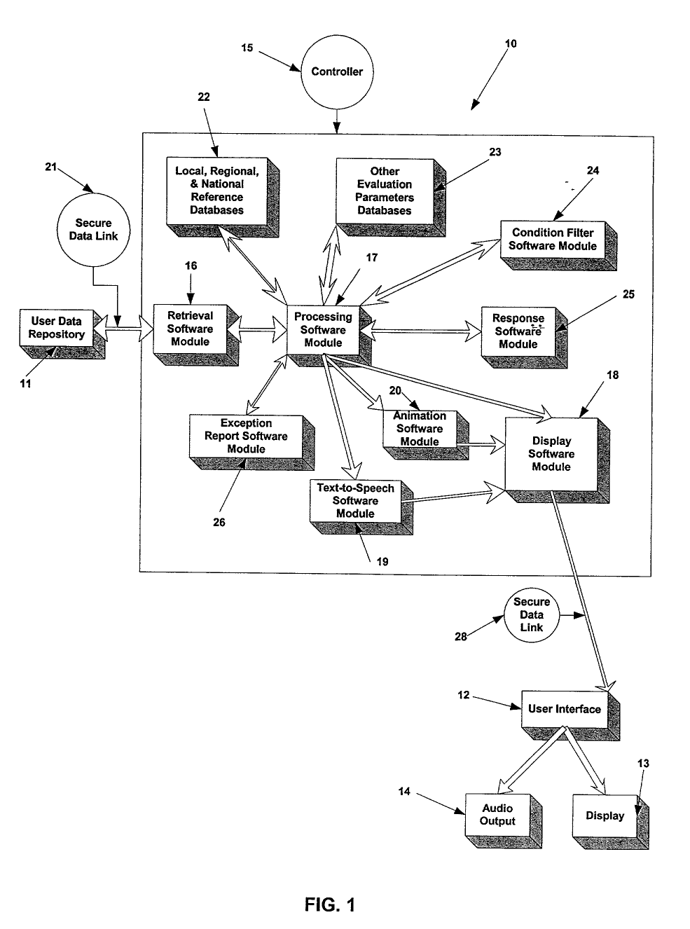

Referring to the drawings and, in particular to FIG. 1, there is illustrated a reporting system 10 for evaluating and improving the financial and operational performance of an individual, business, or business unit (collectively referred to herein as the “user”), according to one embodiment of the present invention. The reporting system 10 includes a data repository 11 electronically retaining financial and operational performance data for the user, at least one user interface 12 having a display 13 and at least one audio output 14, and a controller 15 interfacing with the data repository and the user interface.

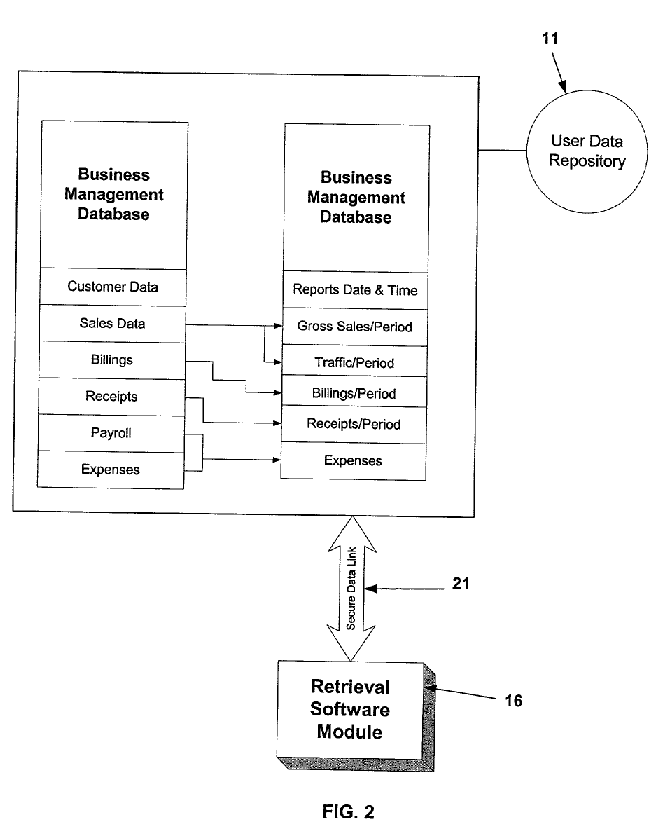

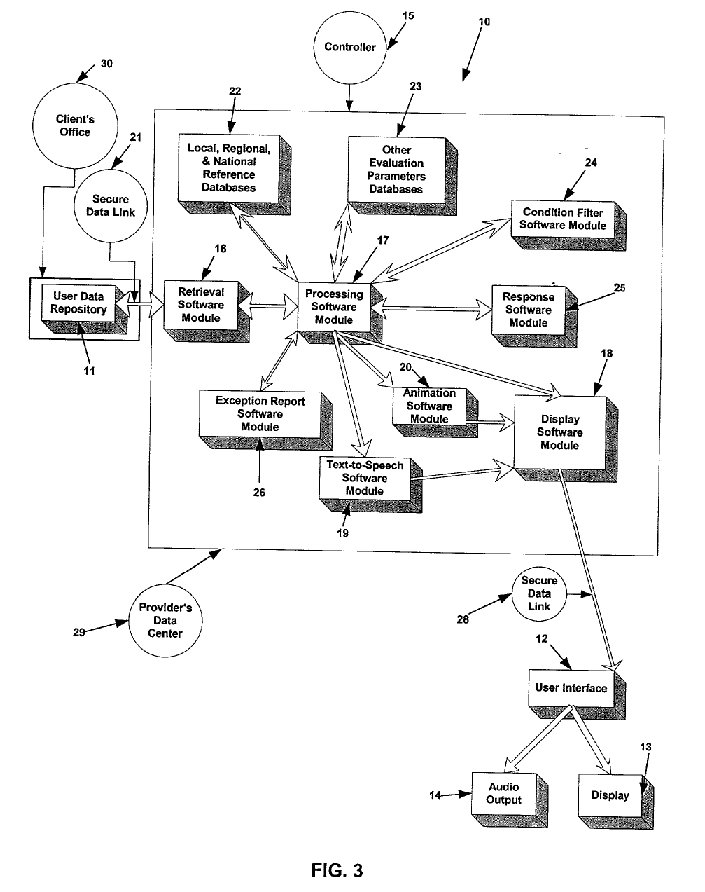

As illustrated in FIG. 2, the data repository 11 retains financial and operational performance data for the user, including, by way of example and not for purposes of limitation, customer data, sales data, billings, receipts, payroll, expenses, and inventory. In one embodiment, the data repository 11 comprises a computer or microprocessor (not shown) operating under software control (“the user's computer system”). The software used in connection with the user's computer system will vary depending on the nature of the user's business, but preferably will include some form of accounting, scheduling, inventory, and/or billing software. The user's financial and operational performance data can be entered manually into the data repository 11 by the user or an employee using a keyboard, mouse, scanner or other input device, as is known in the art. For example, the data can be entered periodically by the user during the normal course of business for accounting or billing purposes, or can be entered by the user in response to a specific inquiry from the reporting system 10 detailing the desired data. In one embodiment, a data capture or data mining software module (not shown) is resident on the user's computer system. Advantageously, the data capture software module can be instructed to automatically capture and compile the desired financial and operational data in a form that can be subsequently transferred to the controller 15, as described below. As illustrated in FIG. 3, the data repository 11 is preferably located at the user's premises 30, although the data repository can also be maintained at the provider's data center 29.

The user interface 12 of the reporting system 10 preferably comprises a computer (not shown) operating under software control. The user interface 12 includes a display or monitor 13 and at least one audio output 14, such as an internal or external speaker or speakers. The computer and display 13 are preferably adapted to support applications or software for generating complex graphics, i.e., the computer has sufficient memory and a processor with sufficient processing speed to process graphics output.

The controller 15 comprises a computer or microprocessor (not shown) operating under software control. Preferably, the controller includes hardware (not shown) and associated software for data storage. In one embodiment, the controller 15 comprises a retrieval software module 16 adapted to retrieve data from the data repository 11; a processing software module 17 interfacing with the retrieval software module and being adapted to process the data retrieved based on predetermined parameters; a display software module 18 interfacing with the processing software module and the user interface 12 and being adapted to display the processed data as a performance report on the display 13 of the user interface; at least one text-to-speech software module 19 interfacing with the processing software module and the audio output 14 of the user interface 12; and at least one animation software module 20 interfacing with the processing software module 17, the display software module 18 and the text-to-speech software module 19.

As illustrated in FIGS. 1-3, the retrieval software module 16 of the controller 15 accesses the data repository 11 through a secure data link 21. The data link 21 can be either electrical or optical and can include, by way of example and not for purposes of limitation, a satellite or other wireless connection, the Internet or world wide web, a local area network or LAN, a wide area network or WAN, an Intranet, or an Extranet. The retrieval software module 16 is adapted to retrieve data from the data repository 11. According to one embodiment, as discussed above, the data repository 11 includes a data capture software module (not shown) that captures and compiles the desired financial and operational information contained in the data repository. According to this embodiment, the retrieval software module 16 is adapted to retrieve the financial and operational information by communicating periodically with the data capture software module over the secure data link 21. If data mining of the data repository 11 is not feasible for cost or technical reasons, the user can communicate through the user's computer system directly with the retrieval software module 16 of the controller 15. For example, using the user's computer system the user can periodically fill out a form posted over the secure data link 21, such as a secure web site. Alternatively, the user can periodically fill out the form on the user's computer system and then transmit the form over the secure data link 21 to the retrieval software module 16 of the controller 15, such as through an email. The data retrieved from the data repository 11 preferably is stored locally by the controller 15 in an electronic form.

The security of the secure data link 21 is provided and maintained using network security capabilities such as intrusion detection, content screening, URL blocking and bandwidth management. Examples of network security capabilities include network protection software, Internet security software, network firewall technology, VPN (Virtual private Network) technology, secured messaging software (i.e., encryption), and URL filtering systems, as is known in the art.

As illustrated in FIG. 1, the controller 15 includes a processing software module 17 for processing the data retrieved from the data repository 11 by the retrieval software module 16. The data is processed by the processing software module 17 according to predetermined parameters that will vary depending on the nature of the user's business. According to one embodiment of the present invention, as illustrated in FIGS. 1 and 3, the controller 15 includes local, regional and national reference databases 22, as well as other evaluation parameters databases 23, which can include de-identified data obtained from other users in a similar business or industry, a condition filter software module 24, a response software module 25, and an exception report software module 26. The databases and software modules of the controller 15 are interconnected and interface together through the processing software module 17.

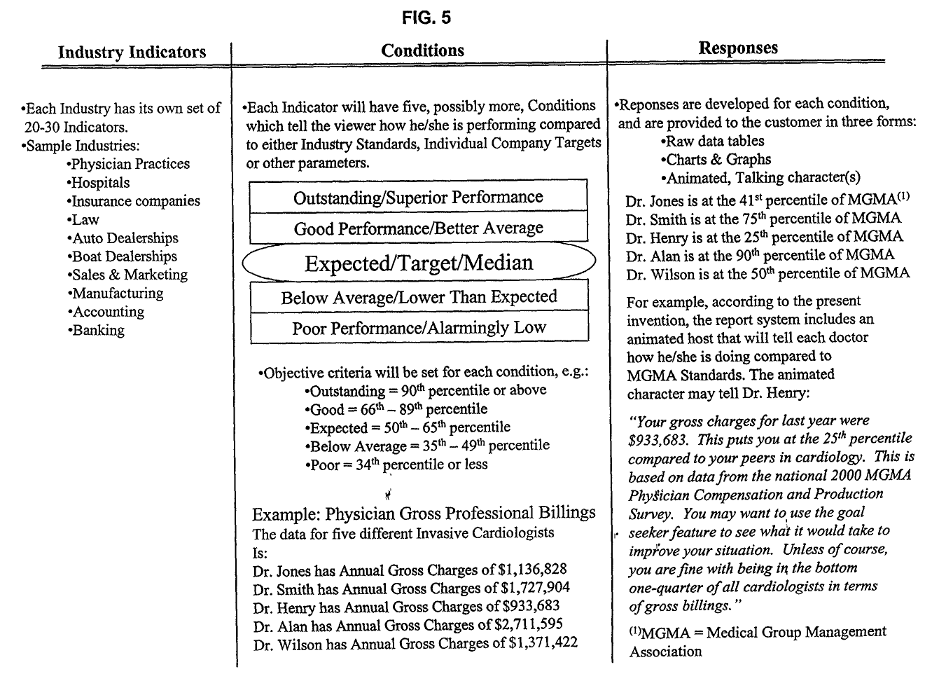

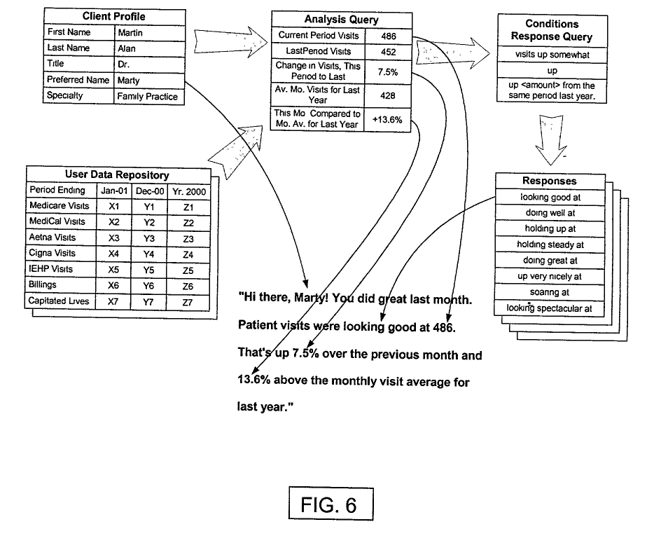

The processing software module 17 preferably processes the data by performing trending and comparison analysis. For example, the condition filter software module 24 of the controller 15 can include a plurality of condition algorithms that are each formulated for analyzing particular types of financial and/or operational information. As illustrated in FIGS. 5 and 6, the condition filter software module 24 based on instructions from the processing software module 17 will compare the user's data in predetermined financial and operational areas to the industry benchmark data or indicators contained in the local, regional and national reference databases 22 or the other evaluation parameters databases 23 and will rate the user's performance in relation to the industry bench mark data. More specifically, the condition filter software module 24 analyzes the data to determine if the user's performance, judged against a preset indicator, is on target, above or below target, and to what degree. The output from the condition filter software module 24 is then transmitted back to the processing software module 17. The processing software module 17 then instructs the response software module 25 to develop responses based on the output of each condition algorithm received from the condition filter software module 24. The responses obtained from the response software module 25 will depend on the financial or operational parameter evaluated and can be in the form numerical or graphical outputs, including, for purposes of example and not limitation, data tables, charts, or graphs. The response software module 25 compiles the responses into a performance report that is communicated back to the processing software module 17 and then to the display software module 18. At the request of the user, the display software module 18 then communicates the performance report to the user interface 12 for presentation on the corresponding display or monitor 13.

At least a portion of the output received by the processing software module 17 from the response software module 25 is communicated to the animation software module 20. The animation software module 20 uses the input from the processing software module 17 to generate one or more animated characters that will be displayed on the monitor 13 of the user interface 12. The output of the animation software module 20 is communicated to the display software module 18 and then, along with the performance report, to the user interface 12 and the corresponding display or monitor 13. Preferably, each animated character simulates the visual appearance of an animal or human, or an object having animal or human like characteristics. For example, each animated character has a face with a mouth and body parts, such as a head, arms, legs, hands, feet, fingers, eyes, and/or ears that visually move separately or together on the monitor of the user interface to emphasize important points or concepts in the performance report. Although the animation software module 20 is illustrated in the FIG. 3 as residing at the provider's data center 29, the animation software module may also reside solely on the user interface 12 or, alternatively, portions of the animation software module may reside at both the provider's data center and on the user interface, which portions can interface through the secure data link 28.

At least a portion of the output received by the processing software module 17 from the response software module 25 is communicated to the text-to-speech software module 19. As illustrated in FIG. 6, the text-to-speech software module 19 converts the input from the processing software module 17 into signals that can be converted into speech or a “message” by the audio output 14 of the user interface 12. The output of the text-to-speech software module 19 is communicated to the display software module 18 and then to the user interface 12 and the corresponding audio output 14. Preferably, the signal from the text-to-speech software module 19 is transmitted to the audio output 14 of the user interface 12 as the mouth of the animated character visually moves on the display 13 so that the aural signal emitted from the audio output is synchronized with the movement of the character's mouth. Preferably, the aural signal is in the form of spoken words. Although the text-to-speech software module 19 is illustrated in the FIG. 3 as residing at the provider's data center 29, the text-to-speech software module may also reside solely on the user interface 12 or, alternatively, portions of the text-to-speech software module may reside at both the provider's data center and on the user interface, which portions can interface through the secure data link 28.

The animated character or characters generated by the animation software module 20 in combination with the aural output generated by the text-to-speech software module 19 visually and aurally evaluate and interpret the performance report displayed on the display 13 of the user interface 12 for the user and provide the user with improvement recommendations. For example, FIG. 6 illustrates hypothetical financial and operational performance data for a healthcare producer along with an illustration of the steps taken by the processing software module 17 in evaluating one operational parameter, patient visits. According to the hypothetical data, the animated character may say “Hi there, Marty! You did great last month. Patient visits were looking good at 486. That's up 7.5% over the previous month and 13.6% above the monthly visit average for last year.” Advantageously, the animated character or characters presented on the display 13 and the corresponding aural messages from the audio output 14 will engage and entertain the user, which will motivate the user to implement the recommendations.

The intensity of the output of the animation software module 20 and the text-to-speech software module 19 depends on level of performance of the user. More specifically, the greater the differential between the financial and operational performance data of the user and the industry norm or indicator, as determined by the analysis conducted by the processing software module 17, the more intense the character animation or movement generated by the animation software module 20 will become, and the stronger or more intense the aural responses or messages from the text-to-speech software module 19 will be to the user. For example, if the user is performing at the industry median, the output from the text-to-speech software module 19 might be “You're performing at the median compared to others in your industry.” If a user was at the 25^{th} percentile to the industry median, the output from the text-to-speech software module might be: “Your performance in this area is alarmingly low compared to your peers. If performance does not immediately improve, you may find yourself in severe financial trouble.” If a user is performing at the 90^{th} percentile of his or her industry benchmark, the output from the text-to-speech software module might be: “Your performance is outstanding compared to your peers. You are in the top 10% of performers in comparable companies.” Other variations can include a knocking sound as the hand of the animated character moves to get the user's attention, shouting or whistling. Similarly, if a user was at the 25^{th} percentile to the industry median, the output from the animation software module 20 might be a frown on the character's face. If a user is performing at the 90^{th} percentile of his or her industry benchmark, the output from the animation software module might be a smile on the character's face and a thumbs-up hand and finger movement.

The performance report generated by the display software module 18 can have a preset reporting format and appearance that the user can customize, including the color, shape, content, and size of the charts, tables and graphs. Preferably, the user can also access the raw data in a summary form. The charts, tables and graphs of the performance report will show both the user's performance for the reporting period, as well as how the user's performance compares to industry and/or company points of reference or goals. The display software module 18 will incorporate the charts and graphs created by the response software module 25 with the animated character and text-to-speech responses generated by the animation software module 20 and text-to-speech software module 19, respectively. Preferably, each user will have a series of animated characters to choose from depending on the nature of the user's business or industry.

Referring to FIGS. 1 and 3, the controller 15 may include an exception report software module 26. The exception report software module 26 will produce an exception report in the event the analysis of the user data by the processing software module 17 indicates a potential problem with the data, or a situation that would warrant direct contact by a representative of the report system provider. The exception report is communicated from the exception report software module 26 to the processing software module 17 and then to the display software module 18, so that the report can be transmitted to the user interface 12 when the user accesses the reporting system 10. According to one embodiment, the exception report is processed through the animation software module 20 and the text-to-speech software module 19 so that the exception report is visually and aurally evaluated by an animated character or characters.

As illustrated in FIGS. 1 and 3, the display software module 18 is connected to the user interface 12 by a secure data link 28. The data link 28 can be either electrical or optical and can include, by way of example and not for purposes of limitation, a satellite or other wireless connection, the Internet or world wide web, a local area network or LAN, a wide area network or WAN, an Intranet, or an Extranet. For example, as illustrated in FIG. 3, the controller 15 and display software module 18 may be resident at the provider's data center 29 while the user interface 12 is located remotely at the client's office 30 or elsewhere. According to this embodiment, the user can access the performance report in the reporting system 10 through the user interface 12 in several ways, for example, by contacting the provider's data center 29 directly using a dial-up, DSL, or cable modem that communicates with the display software module 18 or by connecting to a secure Internet web site hosted by the provider that allows the user to interface with the display software module. The security of the secure data link 28 is provided and maintained using network security capabilities such as intrusion detection, content screening, URL blocking and bandwidth management. Examples of network security capabilities include network protection software, Internet security software, network firewall technology, VPN (Virtual private Network) technology, secured messaging software (i.e., encryption), and URL filtering systems, as is known in the art.

In one embodiment (not shown), the reporting system 10 includes a decision support software module that is adapted to interact with the user. Specifically, the decision support software module will respond to a query by the user concerning a specific financial or operational performance parameter by offering suggestions for performance/profitability improvement or lifestyle enhancement. By way of example, a physician may wish to make $20,000 more in the coming year than he/she did the past year. The doctor could send a query through the user interface 12 and secure data link 28 to the decision support software module indicating the exact increase in the amount of salary (e.g., $160,000 this coming year, compared to $140,000 the past year). The decision support software module will analyze the query from the user and output a response that is communicated to the display software module 18. The display software module will then transmit the response from the decision support software module to the user interface 12, as discussed above, which response is presented on the monitor 13 as a suggestion, for example, “See ‘X’ more patients per half-day session that you are working”, and/or “Add ‘Y’ more half-day sessions of scheduled patient time.” Alternatively, the same physician may wish to hold income constant, but work fewer half-day sessions. In this scenario, the physician could send a query through the user interface 12 and secure data link 28 to the decision support software module indicating the number of sessions he/she desires to work in the coming year. Using financial and performance information already retrieved from the data repository 11 and stored locally at the controller 15, the decision support software module can compare the number of sessions currently being worked and the average number of patients being seen per session with a revised number of patients per session that the doctor would have to see to still make the same amount of income, while working fewer sessions, and advise the physician accordingly. Preferably, the output from the decision support software module is processed through the animation software module 20 and the text-to-speech software module 19 so that the suggestions are visually and aurally reported to the user by an animated character or characters.

Preferably, when the reporting system 10 is installed a number of rules and parameters (“installation parameters”) will be set that the processing software module 17 can utilize to process the financial and operational data of the user. In one embodiment, the controller 15 may include an operating software module (not shown) that will process and implement each of the installation parameters. The installation parameters can include, by way of example and not for purposes of limitation, the specific business parameters to be collected and reported; the high and low limits of normal fluctuation for each financial and operational parameter; the conditions or generalizations of performance (the numerical definition of what is “slightly better” versus “much better” for example) that will be used by the processing software module 17 and the condition filter software module 24; user identification for personalization of the presentation; user security, including identifying how the user will sign on to the reporting system and what information the user may see; and the creation of industry-specific script fragments for the animated characters to speak.

When the user connects to the reporting system 10, the user will be prompted by the display software module 18 to sign on with the user's unique security password. Based on the user's password, which is transmitted from the user interface 12 to the operating software module (not shown) for verification, the operating software module refers to the user's profile to determine when the user last used the reporting system 10, what the user's preferences are as to presentation, and what the user prefers to be referred to as. The operating software module then interfaces with the display software module 18 so that the user's preferences can be incorporated into the user's performance report.

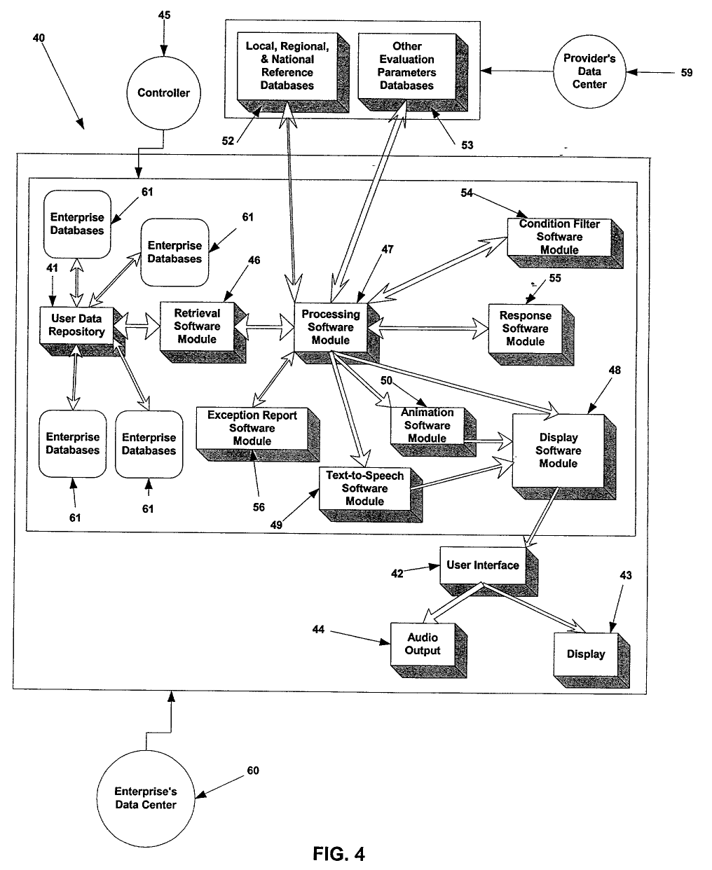

Referring to FIG. 4, wherein like numbers are used to refer to like elements, there is illustrated another embodiment of the reporting system 40 of the present invention for use with businesses having an existing and relatively sophisticated information technology architecture. As discussed above, the reporting system 40 includes a data repository 41 electronically retaining financial and operational performance data for the user, at least one user interface 42 having a display 43 and at least one audio output 44, and a controller 45 interfacing with the data repository and the user interface. The reporting system 40 operates in a similar fashion as discussed above, except that most of the hardware and software of the system is resident at the user's location or office (“the enterprise's data center”) 60. The hardware and software located at the enterprise's data center includes the controller 45, the hardware (not shown) and associated software for data storage, the retrieval software module 46, the processing software module 47, the display software module 48, the at least one text-to-speech software module 49, and the at least one animation software module 50. Only the local, regional, and national references databases 52 and other evaluation parameters databases 53 are located at the provider's data center 59. Advantageously, by locating most of the hardware and software of the reporting system 40 at the enterprise data location, the user is able to take advantage of a more robust data repository 41, as discussed below, while at the same time maintain the business specific-data in-house.

The reporting system 40 may include one or more enterprise databases 61 from which financial and performance information concerning the user is obtained and transferred to a local data repository 41. Preferably, the enterprise's data center 60 includes a data capture or data mining software module (not shown) that can be instructed to automatically capture and compile the desired financial and operational data from the enterprise databases 61 in a form that can be subsequently transferred to the local data repository 41. The enterprise databases 61 represent the computer databases of separate business divisions or units of the user and, thus, provides a significant amount of analogous performance and budgetary information and the like which can be used in preparing the performance report. The connections between the data repository 41 and the enterprise databases 61 can be either electrical or optical and can include, by way of example and not for purposes of limitation, a satellite or other wireless connection, the Internet or world wide web, a local area network or LAN, a wide area network or WAN, an Intranet, or an Extranet. Preferably, if the enterprise databases 61 are remotely located, the connections between the data repository 41 and the enterprise databases 61 are secure data links, as discussed above.

The retrieval and processing of financial and operational performance data in the reporting system 40 and the display of the performance report on the user interface 42 is the same as discussed above with a few exceptions. First, by locating the controller 45 at the enterprises data center 60 the processing software module 47 can utilize the budget and operating benchmarks of the enterprise in processing and evaluating the user performance data and conducting the trending and comparison analysis. For example, a user can be evaluated against others in the enterprise with the same type job (e.g., sales figures). In addition, the animation software module 50 and text-to-speech software 49 module can be customized so that enterprise users can have custom designed characters created that are unique to their company.

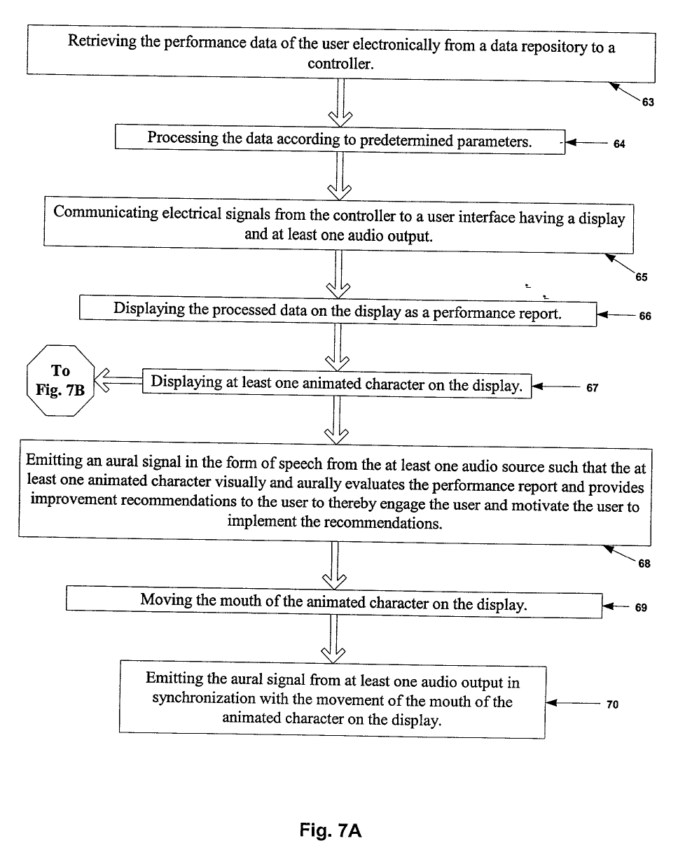

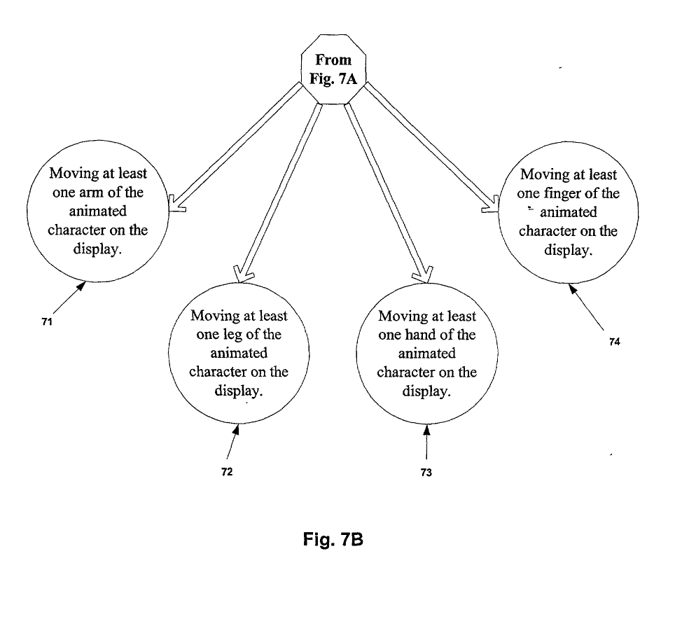

Referring to FIGS. 7A and 7B, there is illustrated a method of evaluating financial and operational performance data of a user. The method includes retrieving the data of the user electronically from a data repository to a controller. See block 63. The controller, according to predetermined parameters, processes the data. See block 64. Signals, which can be either electrical or optical, are communicated from the controller to the at least one user interface having a display and at least one audio output. See block 65. Thereafter, the processed data is displayed on the display as a performance report. See block 66. At least one animated character is displayed on the display. See block 67. An aural signal in the form of speech is emitted from the at least one audio source such that the at least one animated character visually and aurally evaluates the performance report and provides improvement recommendations to the user to thereby engage the user and motivate the user to implement the recommendations. See block 68. In one embodiment, the mouth of the animated character is moved on the display. See block 69. In another embodiment, the aural signal emitted from the at least one audio output is synchronized with the movement of the mouth of the at least one animated character on the display. See block 70. In another embodiment, at least one arm of the animated character is moved on the display. See block 71. In yet another embodiment, at least one leg of the animated character is moved on the display. See block 72. In still another embodiment, at least one hand of the animated character is moved on the display. See block 73. In still another embodiment, at least one finger of the animated character is moved on the display. See block 74. Other body parts of the animated character can also be moved on the display to emphasize important points or concepts. Similarly, the aural signals emitted from the at least one audio output can be used to emphasize important points or concepts.

FIGS. 1-4, 6, 7A and 7B are block diagrams, flowcharts and control flow illustrations of methods, systems and program products according to the invention. It will be understood that each block or step of the block diagrams, flowcharts and control flow illustrations, and combinations of blocks in the block diagrams, flowcharts and control flow illustrations, can be implemented by computer program instructions. These computer program instructions may be loaded onto a computer or other programmable apparatus to produce a machine, such that the instructions which execute on the computer or other programmable apparatus create means or devices for implementing the functions specified in the block diagrams, flowcharts or control flow block(s) or step(s). These computer program instructions may also be stored in a computer-readable memory that can direct a computer or other programmable apparatus to function in a particular manner, such that the instructions stored in the computer-readable memory produce an article of manufacture, including instruction means or devices which implement the functions specified in the block diagrams, flowcharts or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagrams, flowcharts or control flow block(s) or step(s).

Accordingly, blocks or steps of the block diagrams, flowcharts or control flow illustrations support combinations of means or devices for performing the specified functions, combinations of steps for performing the specified functions and program instruction means or devices for performing the specified functions. It will also be understood that each block or step of the block diagrams, flowcharts or control flow illustrations, and combinations of blocks or steps in the block diagrams, flowcharts or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A performance evaluation and improvement system for a user, comprising:
a data repository electronically retaining financial and operational performance data for the user;
at least one user interface having a display and at least one audio output; and
a controller interfacing with said data repository and said at least one user interface, said controller comprising:
a retrieval software module adapted to retrieve data from said data repository;
a processing software module interfacing with said retrieval software module and being adapted to process the data based on predetermined parameters;
a display software module interfacing with said processing software module and said at least one user interface and being adapted to display the processed data as a performance report on said display of said at least one user interface;
at least one text-to-speech software module interfacing with said processing software module and said at least one audio output of said at least one user interface; and
at least one animation software module interfacing with said processing software module, said display software module and said at least one text-to-speech software module, said at least one animation software module and said at least one text-to-speech software module being adapted to visually and aurally evaluate the performance report displayed on said display and provide improvement recommendations to the user to thereby engage the user and motivate the user to implement the recommendations.

2. A system according to claim 1 wherein said at least one animation software module provides at least one animated character on said display having a face with a mouth that visually moves.

3. A system according to claim 2 wherein said at least one text-to-speech software module provides a signal to said at least one audio output of said at least one user interface as the mouth of said animated character visually moves on said display so that said at least one audio output emits an aural signal in the form of speech.

4. A system according to claim 1 wherein said at least one animation software module provides at least one animated character on said display having at least one arm that visually moves.

5. A system according to claim 1 wherein said at least one animation software module provides at least one animated character on said display having at least one leg that visually moves.

6. A system according to claim 1 wherein said at least one animation software module provides at least one animated character on said display having a head that visually moves.

7. A system according to claim 1 wherein said at least one animation software module provides at least one animated character on said display having a hand that visually moves.

8. A system according to claim 1 wherein said at least one animation software module provides at least one animated character on said display having a foot that visually moves.

9. A system according to claim 1 wherein said at least one animation software module provides at least one animated character on said display having at least one finger that visually moves.

10. A method of evaluating financial and operational performance data of a user, comprising:
retrieving the performance data of the user electronically from a data repository and providing it to a controller;
processing the data according to predetermined parameters;
communicating electrical signals from the controller to at least one user interface having a display and at least one audio output;
displaying the processed data on the display as a performance report;
displaying at least one animated character on the display; and
emitting an aural signal in the form of speech from the at least one audio source such that the at least one animated character visually and aurally evaluates the performance report and provides improvement recommendations to the user to thereby engage the user and motivate the user to implement the recommendations.

11. A method according to claim 10 further comprising moving the mouth of the animated character on the display.

12. A method according to claim 11 further comprising emitting the aural signal from at least one audio output in synchronization with the movement of the mouth of the animated character on the display.

13. A method according to claim 10 further comprising moving at least one arm of the animated character on the display.

14. A method according to claim 10 further comprising moving at least one leg of the animated character on the display.

15. A method according to claim 10 further comprising moving at least one hand of the animated character on the display.

16. A method according to claim 10 further comprising moving at least one finger of the animated character on the display.
